(19) United States
(12) Patent Application Publication
(10) Pub. No.: US 2023/0228365 A1
(43) Pub. Date: Jul. 20, 2023

(54) HOLDING DEVICE AND HOLDING METHOD

(71) Applicant: SONY GROUP CORPORATION, TOKYO (JP)

(72) Inventors: KOKI WATANABE, TOKYO (JP); TOMONORI OGURA, TOKYO (JP); HIROKI SATO, TOKYO (JP); HAJIME TAKANO, TOKYO (JP)

(21) Appl. No.: 18/000,812

(22) PCT Filed: May 28, 2021
(86) PCT No.: PCT/JP2021/020354

§ 371 Date: Dec. 5, 2022

(30) Foreign Application Priority Data
Jun. 12, 2020 (JP) 2020-102100

(51) Int. Cl. F16M 11/04; F16M 13/04; G05D 1/00

(52) U.S. Cl. CPC F16M 11/041; F16M 13/04; G05D 1/0016; G06F 1/1626

(57) ABSTRACT

The present disclosure relates to a holding device and a holding method that enable an object, such as a mobile terminal, to be held more stably.

The present disclosure includes a first member and a second member that slides telescopically with respect to the first member. The first member is provided with: a fixing member that fixes the second member by frictional force by being pressed by the second member that slides inside the first member; and a pressing mechanism that presses the fixing member against the second member. The present disclosure can be applied to, for example, a tablet holder.

### TECHNICAL FIELD

The present disclosure relates to a holding device and a holding method, and more particularly to a holding device and a holding method that enable an object such as a mobile terminal to be held more stably.

### BACKGROUND ART

Patent Document 1 discloses an extended controller for playing games on a mobile phone, the extended controller including a holding mechanism that holds the mobile phone at a center and a handheld structure that protrudes to both sides of the holding mechanism, the handheld structure being provided with operation elements operated by the fingertips of a user. Examples of the holding mechanism include a push lock mechanism and a spring mechanism.

In recent years, there is known a technology in which a communication device for piloting a small unmanned aerial vehicle (so-called drone) is used in combination with a mobile terminal, such as a tablet terminal or a smartphone, to display an aerial image and information indicating the situation of the drone.

### CITATION LIST

### Patent Document

Patent Document 1: Japanese Patent Application Laid-Open No. 2003-18275

### SUMMARY OF THE INVENTION

### Problems to be Solved by the Invention

Under such circumstances, a mechanism for more stably holding an object such as a mobile terminal is required.

The present disclosure has been made in view of such circumstances, and an object of the present disclosure is to enable an object such as a mobile terminal to be held more stably.

### Solutions to Problems

A holding device according to the present disclosure includes a first member and a second member that slides telescopically with respect to the first member. The first member is provided with: a fixing member that fixes the second member by frictional force by being pressed by the second member that slides inside the first member; and a pressing mechanism that presses the fixing member against the second member.

A holding method according to the present disclosure in which a holding device includes a first member having a placement surface and a first abutment portion that abuts on one side of an object placed on the placement surface, and a second member sliding telescopically with respect to the first member and having a second abutment portion that abuts on another side that faces the one side of the object abutting on the first abutment portion, the first member being provided with a fixing member that fixes the second member by frictional force by being pressed by the second member that slides inside the first member, and a pressing mechanism that presses the fixing member against the second member, in which the holding device holds the object by the second member being fixed by the fixing member in a state in which the object is sandwiched between the first abutment portion and the second abutment portion.

In the present disclosure, a first member and a second member that slides telescopically with respect to the first member are provided, and the first member is provided with: a fixing member that fixes the second member by frictional force by being pressed by the second member that slides inside the first member; and a pressing mechanism that presses the fixing member against the second member.

### BRIEF DESCRIPTION OF DRAWINGS

FIG. 1 is a front view illustrating the appearance of a communication device.

FIG. 2 is a side view illustrating the appearance of the communication device.

FIG. 3 is an explanatory view of the angle adjustment of a tablet terminal.

FIG. 4 is an explanatory view of the angle adjustment of the tablet terminal.

FIG. 5 is a perspective view illustrating the appearance of a tablet holder.

FIG. 6 is a perspective view illustrating the appearance of the tablet holder.

FIG. 7 is a side sectional view illustrating the internal structure of the tablet holder.

FIG. 8 is an explanatory view of the flow of holding the tablet terminal.

FIG. 9 is an explanatory view of the flow of holding the tablet terminal.

FIG. 10 is an explanatory view of the flow of holding the tablet terminal.

### MODE FOR CARRYING OUT THE INVENTION

Hereinafter, modes (hereinafter referred to as embodiments) for carrying out the present disclosure will be described. Note that the description will be given in the following order.

1. Appearance of Communication Device

2. Appearance and Internal Structure of Tablet Holder

3. Flow of Holding Tablet Terminal

### 1. Appearance of Communication Device

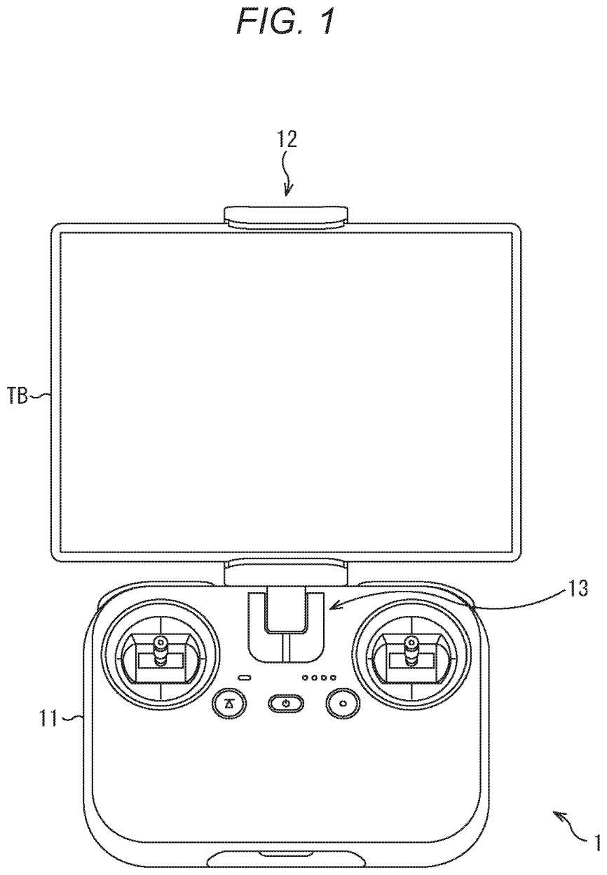

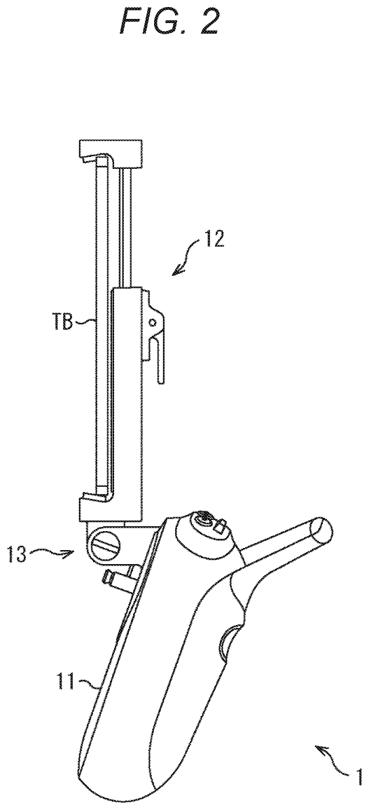

FIGS. 1 and 2 illustrate the appearance of a communication device having a tablet holder that holds a tablet terminal. FIG. 1 illustrates a front view of the communication device in which the display surface of the tablet terminal is perpendicular to a horizontal plane, and FIG. 2 illustrates a side view of the communication device in a similar state.

A communication device 1 is a controller for piloting an unmanned aerial vehicle (drone) (not illustrated), and is provided with a body 11, a tablet holder 12, and a joining member 13.

The body 11 serving as a communication device transmits and receives various signals by communicating with the drone. On the operation surface of the body 11, various buttons are provided in addition to an operation stick (left stick) for moving the drone forward/backward and turning left/right, and an operation stick (right stick) for moving the drone up/down and left/right. These buttons include a power button for turning on/off the power, a selection button for selecting the settings or modes of the communication device 1, and the like.

When the left and right operation sticks are operated by the user, the body 11 transmits a control signal corresponding to the operation to the drone via wireless communication. This allows the user to pilot the drone.

The tablet holder 12 serving as a holding device is joined to the body 11 by the joining member 13.

A tablet terminal TB is held by the tablet holder 12. The tablet terminal TB configured as an information processing terminal is electrically connected to the body 11 in a wired or wireless manner, and communicates with the body 11.

The tablet terminal TB has a display having a touch panel function, and displays various types of information acquired from the drone. The drone is equipped with a camera for capturing (aerial capturing) images of landscapes on the ground during flight, and the tablet terminal TB displays images aerially captured by the camera, information indicating the situation of the drone and the settings of the camera, and the like. Therefore, the user can check the aerial images, the situation of the drone, the settings of the camera, and the like while piloting the drone.

Note that the tablet terminal TB may acquire the information from the drone via the body 11 that wirelessly communicates with the drone, or may acquire the information by directly performing wireless communication with the drone.

The tablet holder 12 holds the tablet terminal TB by sandwiching the upper side and the lower side of the rectangular tablet terminal TB placed on the placement surface thereof. The tablet holder 12 is provided with the joining member 13 at the lower end thereof, and the joining member 13 joins the lower end of the tablet holder 12 and the upper center of the operation surface of the body 11. The joining member 13 has a pivot mechanism (hinge mechanism) that enables the angle adjustment of the tablet terminal TB held by the tablet holder 12.

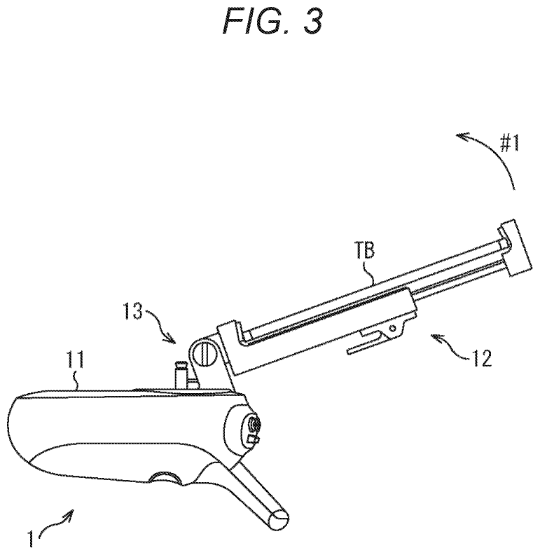

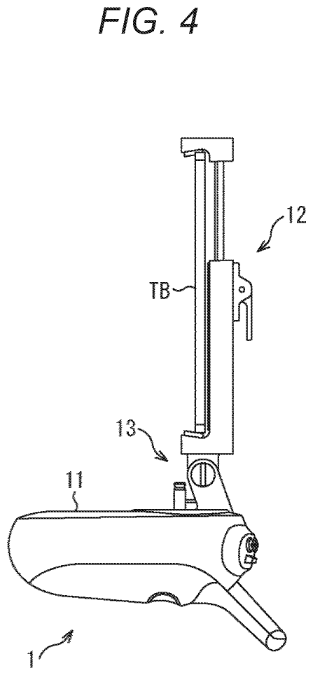

Specifically, as illustrated in FIG. 3, from a state in which the operation surface of the body 11 is horizontal, the upper end of the tablet holder 12 is configured so as to be pivotable in the direction of arrow #1 in the drawing about the joining member 13. Therefore, as illustrated in FIG. 4, the angle of the tablet terminal TB can be adjusted such that the display surface of the tablet terminal TB is perpendicular to the operation surface of the body 11.

Note that the structure and presence or absence of the pivot mechanism of the joining member 13 are not limited to the above-described example. Furthermore, although the tablet holder 12 sandwiches the upper side and the lower side of the tablet terminal TB, for example, the tablet terminal TB may be held by sandwiching the left side and the right side of the tablet terminal TB.

### 2. Appearance and Internal Structure of Tablet Holder

Hereinafter, the appearance and the internal structure of the tablet holder 12 will be described.

(Appearance of Tablet Holder)

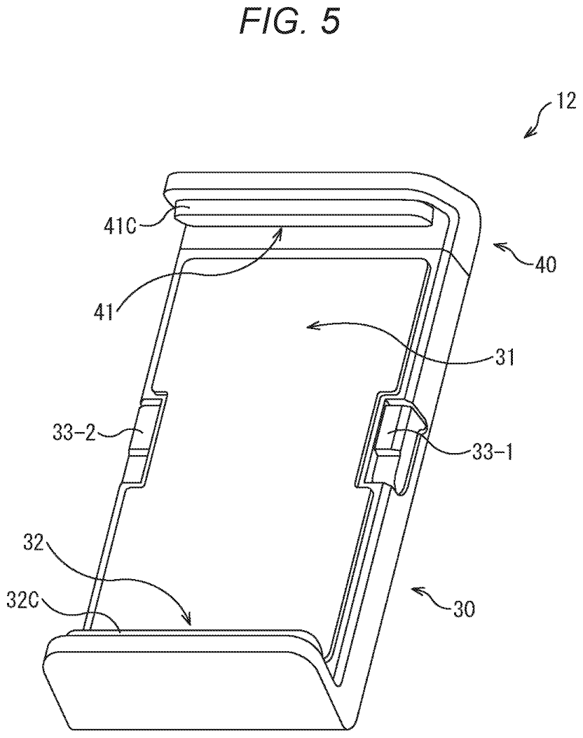

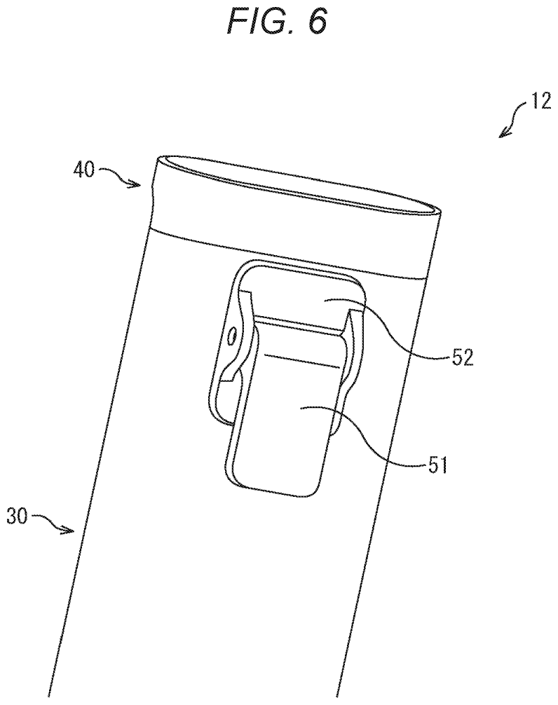

FIGS. 5 and 6 are perspective views illustrating the appearance of the tablet holder 12.

When the side of the tablet holder 12 on which the tablet terminal TB is placed is the front, FIG. 5 illustrates the appearance of the tablet holder 12 viewed from the front, and FIG. 6 illustrates the appearance of the tablet holder 12 viewed from the rear.

The tablet holder 12 is configured from a first member 30 and a second member 40.

The first member 30 has a placement surface 31 and a first abutment portion 32 that abuts on one side (specifically, the lower side of the tablet terminal TB) of an object placed on the placement surface 31. The abutment surface of the first abutment portion 32 which abuts on the tablet terminal TB forms an angle slightly smaller than a right angle with the placement surface 31.

The second member 40 slides telescopically with respect to the first member 30. Furthermore, the second member 40 has a second abutment portion 41 that abuts on another side (specifically, the upper side of the tablet terminal TB) that faces one side of the object abutting on the first abutment portion 32 of the first member 30. The abutment surface of the second abutment portion 41 which abuts on the tablet terminal TB also forms an angle slightly smaller than a right angle with the placement surface 31.

Most of the second member 40 is housed inside the first member 30, and the housed portion of the second member 40 slides and is exposed from the first member 30 by the upper end of the second member 40 illustrated in FIGS. 5 and 6 being drawn upward in the drawing.

The placement surface 31 and first abutment portion 32 of the first member 30 and the second abutment portion 41 of the second member 40 form a substantially U-shape in side view. In a state in which the tablet terminal TB is placed on the placement surface 31 of the first member 30 so that the lower side thereof abuts on the first abutment portion 32, the second member 40 is slid to cause the second abutment portion 41 to abut on the upper side of the tablet terminal TB, whereby the tablet terminal TB is sandwiched therebetween.

Note that cushion members 32C and 41C are provided on the abutment surface of the first abutment portion 32 which abuts on the tablet terminal TB and the abutment surface of the second abutment portion 41 which abuts on the tablet terminal TB, respectively. Therefore, the tablet terminal TB is stably sandwiched between the first abutment portion 32 and the second abutment portion 41 without damaging the tablet terminal TB.

Abutment members 33-1 and 33-2 are provided at center left and right ends of the first member 30. The abutment members 33-1 and 33-2 are configured so that the upper ends thereof are pivotable about the lower ends thereof, and the abutment members 33-1 and 33-2 become perpendicular to the placement surface 31. Therefore, a mobile terminal, such as a smartphone, having a smaller height (width) than the tablet terminal TB, can also be sandwiched between the abutment members 33-1 and 33-2 and the second abutment portion 41.

Specifically, in a state in which the smartphone is placed on the placement surface 31 of the first member 30 so that the lower side thereof abuts on the abutment members 33-1 and 33-2, the second member 40 is slid to cause the second abutment portion 41 to abut on the upper side of the smartphone, whereby smartphone is sandwiched therebetween.

As illustrated in FIG. 6, a cam lever 51 and a coupling member 52 are provided on the rear surface of the first member 30.

Although details will be described later, the first member 30 is provided with a fixing member that fixes the slide of the second member 40 by frictional force by being pressed by the second member 40 sliding inside the first member, and a pressing mechanism that presses the fixing member against the second member 40.

The pressing mechanism is configured by including the cam lever 51 and the coupling member 52. The cam lever 51 is pivotably coupled to the housing rear surface of the first member 30 by the coupling member 52. By pivoting the cam lever 51, the fixing member is pressed against the second member 40 inside the first member 30, and the slide of the second member 40 is fixed.

(Internal Structure of Tablet Holder)

Here, the internal structure of the tablet holder 12 will be described.

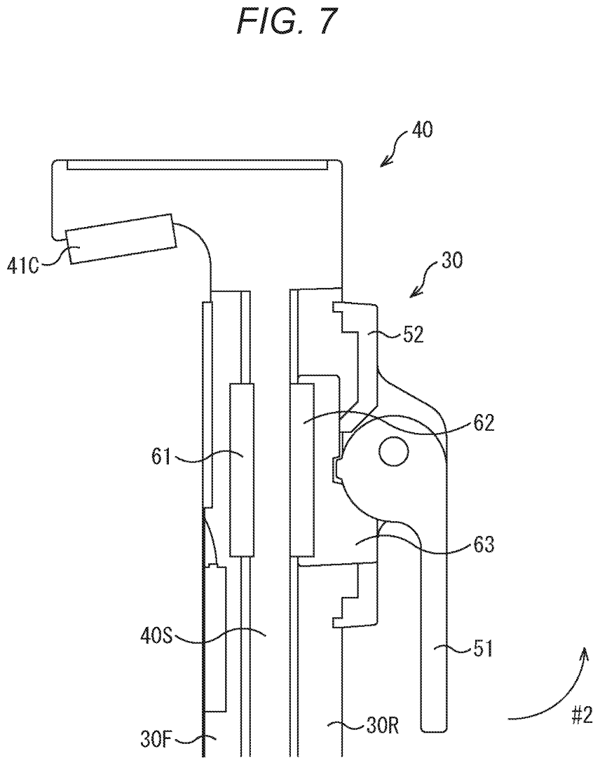

FIG. 7 is a side sectional view illustrating the internal structure of the tablet holder 12 (mainly the first member 30). In FIG. 7, the internal structure of the tablet holder 12 below the cam lever 51 is not illustrated.

As illustrated in FIG. 7, the housing of the first member 30 is configured from a front cover member 30F that constitutes the front side of the first member 30 and a rear cover member 30R that constitutes the rear side of the first member 30. Between the front cover member 30F and the rear cover member 30R, there is provided a space in which a plate-shaped slide member 40S, which serves as the housed portion of the second member 40, can move vertically. That is, when the slide member 40S moves vertically in the space between the front cover member 30F and the rear cover member 30R, the second member 40 slides telescopically with respect to the first member 30.

In the space between the front cover member 30F and the rear cover member 30R, fixing members 61 and 62 are provided at positions corresponding to the cam lever 51 and the coupling member 52. The fixing members 61 and 62 are provided at positions facing each other with the slide member 40S interposed therebetween.

The fixing member 61 is provided in the space between the front cover member 30F and the rear cover member 30R so as to be in slight contact with the front cover member 30F-side surface of the slide member 40S.

Meanwhile, the fixing member 62 is supported in the space between the front cover member 30F and the rear cover member 30R by a support member 63, and is provided so as to be pressed against the rear cover member 30R-side surface of the slide member 40S.

The pressing mechanism described above is configured from the cam lever 51, the coupling member 52, and the support member 63, and generates a pressing force for pressing the fixing member 62 against the slide member 40S from the rear surface of the tablet holder 12 (the back side of the placement surface 31). Specifically, the cam lever 51 transmits a pressing force to the support member 63 by pivoting, so that the fixing member 62 is pressed against the rear cover member 30R-side surface of the slide member 40S.

The cam lever 51 can pivot approximately 90° from the state shown in FIG. 7 (hereinafter, also referred to as a 0° state) in the direction indicated by arrow #2 in the figure.

In the state shown in FIG. 7, the fixing member 62 is pressed against the slide member 40S by the pressing force from the cam lever 51. When the fixing member 62 is pressed against the slide member 40S, the slide member 40S bends slightly toward the fixing member 61. Therefore, the slide member 40S (second member 40) is fixed by the frictional force of the fixing member 61 and the fixing member 62.

Meanwhile, in a state in which the cam lever 51 is pivoted 90°, the fixing member 62 is released from the pressing force from the cam lever 51, and the pressure of the fixing member 62 against the slide member 40S is released. Therefore, the slide member 40S (second member 40) slides telescopically with respect to the first member 30.

The fixing members 61 and 62 include a material having a relatively high coefficient of friction, capable of fixing the slide member 40S. For example, the fixing members 61 and 62 include an elastic body such as rubber or sponge, a hard material such as aramid fiber or steel fiber, or a wooden material such as cork.

The present invention is not limited thereto, and the fixing member 61 and the fixing member 62 may include predetermined resin, and the slide member 40S may include a material having a relatively high coefficient of friction, such as the above-described elastic body or hard material. Furthermore, the surface of the slide member 40S may be coated with a material having a high coefficient of friction or may be coated with paint containing beads of a predetermined material.

Furthermore, the cam lever 51 can be configured as an eccentric cam lever having an eccentric cam. In this case, the support member 63 is configured to transmit a pressing force for pressing the fixing member 62 against the slide member 40S and a force in the contraction direction (downward in FIG. 7) of the second member 40 (slide member 40S), by the pivoting of the cam lever 51.

Specifically, the support member 63 has a concave arc-shaped cross section in contact with about lower left ¼ of the cylindrical cam portion of the cam lever 51. The pivoting of the cam lever 51 having the eccentric cam applies a force in the lower left direction in the drawing to the concave arc-shaped cross-sectional portion of the support member 63.

Therefore, the second member 40 (slide member 40S) is fixed while being drawn downward by the fixing member 62, and as a result, the tablet terminal TB can be more firmly held.

Note that by changing the amount of eccentricity of the eccentric cam, the pressing force on the fixing member 62 can be adjusted to a desired strength.

As a structure for fixing the second member 40 slid with respect to the first member 30, a ratchet lock structure can be used, but in this case, the position where the second member 40 is fixed can be determined only in stages.

Meanwhile, with the above configuration, since the second member 40 is fixed by the fixing member 62 being pressed against the second member 40 by the pressing mechanism including the cam lever 51, the position to fix the second member 40 can be flexibly determined. As a result, the tablet terminal TB can be held more stably regardless of the size of the tablet terminal TB.

Note that in the above description, the pressing mechanism is configured by including the cam lever 51. However, the pressing mechanism may include a clamp lever instead of the cam lever 51, or may adopt any configuration capable of fixing the second member 40 by one-touch operation.

### 3. Flow of Holding Tablet Terminal

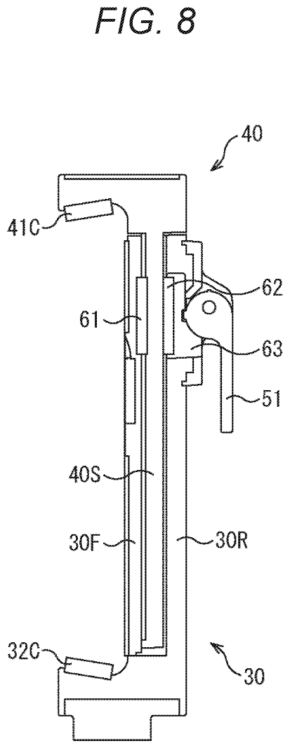

Next, the flow of holding the tablet terminal TB by the tablet holder 12 will be described with reference to FIGS. 8 to 10.

FIG. 8 illustrates a side sectional view of the tablet holder 12 in a state in which the second member 40 (slide member 40S) is housed inside the first member 30.

In FIG. 8, the cam lever 51 is in the 0° state, and the second member 40 (slide member 40S) is fixed by the fixing member 61 and the fixing member 62 in a state of being housed inside the first member 30.

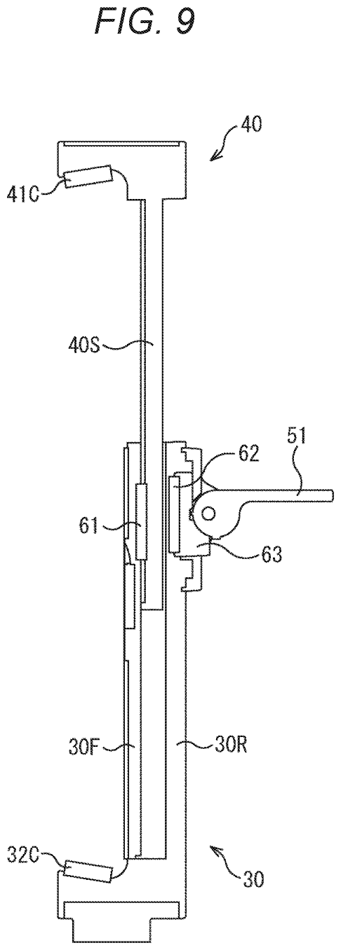

When the cam lever 51 is pivoted 90° from the state shown in FIG. 8, as illustrated in FIG. 9, the second member 40 (slide member 40S) is released from the fixation by the fixing member 61 and the fixing member 62, and becomes movable in the extension direction (upward direction in the drawing).

From the state shown in FIG. 9, the tablet terminal TB is sandwiched between the first abutment portion 32 and the second abutment portion 41.

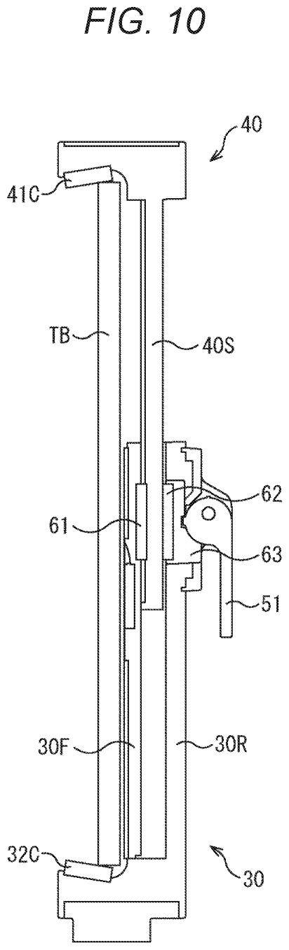

In this state, when the cam lever 51 is returned to the 0° state, as illustrated in FIG. 10, the second member 40 (slide member 40S) is fixed by the fixing member 61 and the fixing member 62 in a state in which the tablet terminal TB is sandwiched between the first abutment portion 32 and the second abutment portion 41.

According to the above flow, it is possible to more stably hold the tablet terminal TB regardless of the size of the tablet terminal TB.

The example in which the technology according to the present disclosure is applied to the tablet holder 12 mounted on the communication device 1 for piloting a drone has been described above. The present disclosure is not limited to this, and the technology according to the present disclosure can be applied to any holding device that holds a plate-shaped object by sandwiching two opposing sides of the object.

The embodiments of the present technology are not limited to the above-described embodiments, and various modifications can be made without departing from the gist of the present technology.

Furthermore, the effects described in the present specification are merely examples and are not limited, and other effects may be provided.

Furthermore, the present disclosure can have the following configurations.

(1)

A holding device

including

a first member and

a second member that slides telescopically with respect to the first member, in which

the first member

is provided with:

a fixing member that fixes the second member by frictional force by being pressed by the second member that slides inside the first member; and

a pressing mechanism that presses the fixing member against the second member.

(2)

The holding device according to (1), in which

the first member has a placement surface and a first abutment portion that abuts on one side of an object placed on the placement surface, and

the second member has a second abutment portion that abuts on another side that faces the one side of the object abutting on the first abutment portion.

(3)

The holding device according to (2), in which

the object is held by the second member being fixed by the fixing member in a state in which the object is sandwiched between the first abutment portion and the second abutment portion.

(4)

The holding device according to (3), in which

the pressing mechanism generates a pressing force for pressing the fixing member against the second member from a back side of the placement surface.

(5)

The holding device according to (4), in which

the pressing mechanism includes a cam lever that transmits the pressing force to a support member that supports the fixing member.

(6)

The holding device according to (5), in which

the cam lever has an eccentric cam, and

the support member is configured to transmit a force in a contraction direction of the second member together with the pressing force by pivoting of the cam lever.

(7)

The holding device according to any one of (1) to (6), in which

the fixing member includes an elastic body.

(8)

The holding device according to (7), in which

the elastic body includes rubber.

(9)

The holding device according to any one of (1) to (6), in which

the fixing member includes a hard material.

(10)

The holding device according to (9), in which

the hard material includes aramid fiber.

(11)

The holding device according to (9), in which

the hard material includes steel fiber.

(12)

The holding device according to any one of (2) to (11), in which

the object includes an information processing terminal.

(13)

The holding device according to (12), further including

a joining member that is joined to a communication device that is electrically connected to the information processing terminal.

(14)

The holding device according to (13), in which
the joining member has a pivot mechanism that enables angle adjustment of the held information processing terminal.

(15)

The holding device according to (13) or (14), in which

the communication device communicates with an unmanned aerial vehicle.

(16)

A holding method in which

a holding device includes a first member having a placement surface and a first abutment portion that abuts on one side of an object placed on the placement surface, and a second member sliding telescopically with respect to the first member and having a second abutment portion that abuts on another side that faces the one side of the object abutting on the first abutment portion,

the first member being provided with a fixing member that fixes the second member by frictional force by being pressed by the second member that slides inside the first member, and a pressing mechanism that presses the fixing member against the second member, in which

the holding device holds the object by the second member being fixed by the fixing member in a state in which the object is sandwiched between the first abutment portion and the second abutment portion.

### REFERENCE SIGNS LIST

1 Communication device
11 Body
12 Tablet holder
13 Joining member
30 First member
31 Placement surface
32 First abutment portion
32C Cushion member
40 Second member
41 Second abutment portion
41C Cushion member
51 Cam lever
52 Coupling member
61 Fixing member
62 Fixing member
63 Support member

1. A holding device
comprising
a first member and
a second member that slides telescopically with respect to the first member, wherein
the first member
is provided with:
a fixing member that fixes the second member by frictional force by being pressed by the second member that slides inside the first member; and
a pressing mechanism that presses the fixing member against the second member.

2. The holding device according to claim 1, wherein
the first member has a placement surface and a first abutment portion that abuts on one side of an object placed on the placement surface, and
the second member has a second abutment portion that abuts on another side that faces the one side of the object abutting on the first abutment portion.

3. The holding device according to claim 2, wherein
the object is held by the second member being fixed by the fixing member in a state in which the object is sandwiched between the first abutment portion and the second abutment portion.

4. The holding device according to claim 3, wherein
the pressing mechanism generates a pressing force for pressing the fixing member against the second member from a back side of the placement surface.

5. The holding device according to claim 4, wherein
the pressing mechanism includes a cam lever that transmits the pressing force to a support member that supports the fixing member.

6. The holding device according to claim 5, wherein
the cam lever has an eccentric cam, and
the support member is configured to transmit a force in a contraction direction of the second member together with the pressing force by pivoting of the cam lever.

7. The holding device according to claim 1, wherein
the fixing member includes an elastic body.

8. The holding device according to claim 7, wherein
the elastic body includes rubber.

9. The holding device according to claim 1, wherein
the fixing member includes a hard material.

10. The holding device according to claim 9, wherein
the hard material includes aramid fiber.

11. The holding device according to claim 9, wherein
the hard material includes steel fiber.

12. The holding device according to claim 2, wherein
the object includes an information processing terminal.

13. The holding device according to claim 12, further comprising
a joining member that is joined to a communication device that is electrically connected to the information processing terminal.

14. The holding device according to claim 13, wherein
the joining member has a pivot mechanism that enables angle adjustment of the held information processing terminal.

15. The holding device according to claim 13, wherein
the communication device communicates with an unmanned aerial vehicle.

16. A holding method in which
a holding device includes a first member having a placement surface and a first abutment portion that abuts on one side of an object placed on the placement surface, and a second member sliding telescopically with respect to the first member and having a second abutment portion that abuts on another side that faces the one side of the object abutting on the first abutment portion,
the first member being provided with a fixing member that fixes the second member by frictional force by being pressed by the second member that slides inside the first member, and a pressing mechanism that presses the fixing member against the second member, wherein
the holding device holds the object by the second member being fixed by the fixing member in a state in which the object is sandwiched between the first abutment portion and the second abutment portion.
